(19) United States
(12) Patent Application Publication
(10) Pub. No.: US 2001/0047238 A1
(43) Pub. Date: Nov. 29, 2001

(54) Locator apparatus

(76) Inventor: Laura Elijah Hollins, San Bernardino, CA (US)

Correspondence Address: Matthew J. Peirce, Esq., 1550 Starlight Canyon Avenue, Las Vegas, NV, 89123, US

(21) Appl. No.: 09/864,422

(22) Filed: May 23, 2001

Related U.S. Application Data
(60) Provisional application No. 60/206,814, filed on May 25, 2000.

(51) Int. Cl. G01C 21/34

(52) U.S. Cl. 701/202; 701/209

(57) ABSTRACT

A new and improved computer and machine that will help people find a desired location or address before they commence travelling. In order to use this invention, a user would input various information, such as a starting address and a destination address, into the present invention. The present invention would then research its informational database and then print out an appropriate set of directions for a user to use which would provide specific detail for the user to get from the starting address to the destination address.

### BACKGROUND OF THE INVENTION

The present invention concerns that of a new and improved computer and machine that will help people find a desired location or address before they commence travelling.

### DESCRIPTION OF THE PRIOR ART

U.S. Pat. No. 5,839,086, issued to Hirano, discloses a system for providing and displaying recommended navigation information in a vehicle which includes a simple on-board display, a destination selection input keyboard, a beacon receiver, a beacon transmitter and a computer control device on-board the vehicle, in connection with a roadside beacon that is further in communication with a centralized traffic information center.

U.S. Pat. No. 5,486,822, issued to Tenmoku, discloses an optimum route determination apparatus which comprises a plurality of specific points selected from a road map on the basis of a fixed criterion, and an optimum route leading to each destination in which one of the specific points is a departure point and which has been calculated in advance.

U.S. Pat. No. 5,220,507, issued to Kirson, discloses a land vehicle multiple navigation route apparatus includes a computer for calculating at least first and second navigation routes between start and destination locations.

U.S. Pat. No. 5,031,104, issued to Ikeda, discloses an in-vehicle navigator comprises a map memory unit for memorizing road map data consisting of road data comprised of the combination of nodes and links, and background data such as buildings, a location detection unit for detecting a vehicle location, an initialization unit for inputting a destination, and route calculation conditions desired by a vehicle operator, and a route calculation unit for reading road map data containing a current location and the destination from the map memory unit.

### SUMMARY OF THE INVENTION

The present invention concerns that of a new and improved computer and machine that will help people find a desired location or address before they commence travelling. In order to use this invention, a user would input various information, such as a starting address and a destination address, into the present invention. The present invention would then research its informational database and then print out an appropriate set of directions for a user to use which would provide specific detail for the user to get from the starting address to the destination address.

There has thus been outlined, rather broadly, the more important features of a location finding apparatus in order that the detailed description thereof that follows may be better understood and in order that the present contribution to the art may be better appreciated. There are, of course, additional features of the location finding apparatus that will be described hereinafter and which will form the subject matter of the claims appended hereto.

In this respect, before explaining at least one embodiment of the location finding apparatus in detail, it is to be understood that the location finding apparatus is not limited in its application to the details of construction and to the arrangements of the components set forth in the following description or illustrated in the drawings. The location finding apparatus is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present location finding apparatus. It is important, therefore, that the claims be regarded as including such equivalent constructions insofar as they do not depart from the spirit and scope of the present invention.

It is therefore an object of the present invention to provide a location finding apparatus which has all of the advantages of the prior art and none of the disadvantages.

It is another object of the present invention to provide a location finding apparatus which may be easily and efficiently manufactured and marketed.

It is another object of the present invention to provide a location finding apparatus which is of durable and reliable construction.

It is yet another object of the present invention to provide a location finding apparatus which is economically affordable and available for relevant purchasing government entities.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a possible configuration of the present invention.

FIG. 2 shows a handheld/tabletop version of the present invention.

### DESCRIPTION OF THE PREFERRED EMBODIMENT

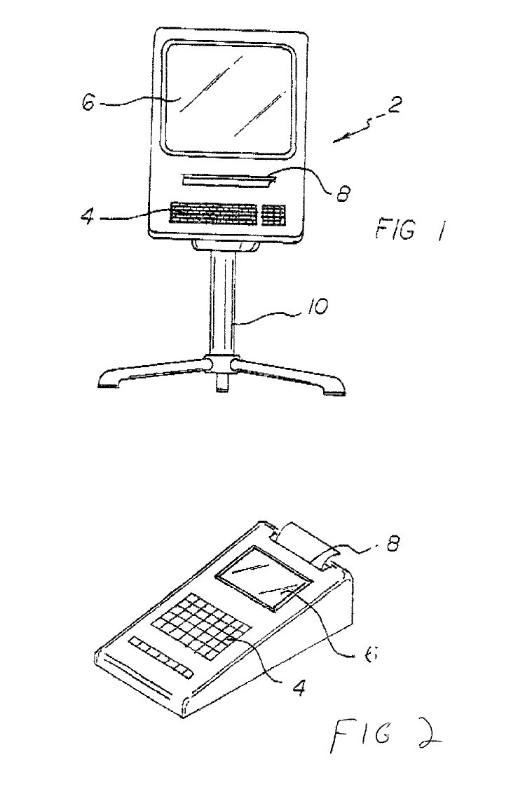

FIG. 1 shows a possible configuration of the present invention. This version is the stand-up version 2 and includes the present invention with a keyboard 4, monitor 6, a paper dispenser 8, and a stand 10. Although the stand 8 shown in FIG. 1 appears to be a tripod, any one of a number of various stands can be used to hold this embodiment properly up.

The present invention would essentially be a computer of limited capacity which would initially take various input from a user. The various input would preferably include a starting address and a destination address to which the user would want to travel to by some standard method of transportation. Other input that could be utilized would be whether the user was driving a truck or a standard vehicle, which might make a difference between the actual route taken. For instance, if a user was driving cargo or other material in an 18-wheeler, a route might be drafted for a user based on knowledge of low bridges and “no trucks allowed” roads or streets. In addition, the present invention would re-route a user around traffic violations and/or construction. Further, the present invention might ask what time a user would be leaving from a specific address on a particular day, and based on this information, might re-route the user around a major city rather than take a user right through a city during a bad traffic time, such as rush hour.

Once a user had inputted the necessary information, the present invention would eventually provide output through paper dispenser 8 in the form of written directions from the starting address to the destination address. In addition to the written directions provided by the present invention, the present invention could also provide a map that would assist people by providing further clarification to the written instructions, which would ideally work with people who are primarily “visual.”

FIG. 2 shows a tabletop version 12 of the present invention. This embodiment shows a version analogous to the version shown in FIG. 1, but a smaller version that could be easily placed on a tabletop or a small portion of a user's desk. This embodiment would be most beneficial to repeated office use and could be used by a single user, as it would take up only a small portion of a user's desk.

The present invention would need to be periodically updated, either through diskettes, CD-ROM's, or through an Internet connection. Such updates would ensure that the present invention would not give erroneous directions and would also ensure that the present invention would have all addresses on file that currently exist.

What I claim as my invention is:

1. An apparatus for providing a travel plan comprising:
(a) a hard drive,
(b) a monitor connected to the hard drive,
(c) a keyboard connected to the hard drive and the monitor, the keyboard capable of receiving inputted data from a user,
(d) power means for providing power to the hard drive,
(e) an internal printer located within the monitor, the internal printer being connected to the hard drive,
(f) a computer program incorporated onto the hard drive, the computer program having a database including all highways, roads, interstates, and other such pathways of travel, the computer program designed to analyze inputted data from a user and provide a travel plan based on several specific variables that would be part of the inputted data,
(g) means for outputting the travel plan for review, and
(h) means for updating the hard drive with new information on a periodic basis.

2. An apparatus for providing a travel plan according to claim I wherein the inputted data would comprise several variables including:
(a) a starting address,
(b) a destination address,
(c) type of vehicle to be used,
(d) desired time of day to commence the travel plan, and
(e) whether a scenic route or direct route would be desired.

3. An apparatus for providing a travel plan according to claim 2 wherein the means for updating the hard drive with new information on a periodic basis further comprises:
(a) A CD-ROM drive incorporated into the hard drive,
(b) A compact disc with updated information including weather information, current construction information, new highway and road information, the compact disc being updated on a periodic basis, the updated information designed to be incorporated into the computer program on the hard drive,
(c) whereby a user would load each compact disc issued on a periodic basis into the CD-ROM drive and load the updated information on the compact disc into the computer program on the hard drive.

4. An apparatus for providing a travel plan according to claim 2 wherein the means for updating the hard drive with new information on a periodic basis further comprises:
(a) A disc drive incorporated into the hard drive,
(b) A set of floppy discs with updated information including weather information, current construction information, new highway and road information, the set being updated on a periodic basis, the updated information designed to be incorporated into the computer program on the hard drive,
(c) whereby a user would load each set of floppy discs issued on a periodic basis into the disc drive and load the updated information on the compact disc into the computer program on the hard drive.

5. An apparatus for providing a travel plan according to claim 2 wherein the means for updating the hard drive with new information on a periodic basis further comprises:
(a) A means for connecting the hard drive to the Internet,
(b) A periodically issued update for the computer program including updated information about weather information, current construction information, new highway and road information, the update being accessible and downloadable through a Internet home page, the update designed to be incorporated into the computer program on the hard drive,
(c) whereby a user would connect to the Internet home page that would include the periodically issued update through the means for connecting the hard drive to the Internet, download the update onto the hard drive, and incorporate the update into the computer program on the hard drive.

6. An apparatus for providing a travel plan according to claim 2 wherein the means for outputting the travel plan for review further comprise
(a) the internal printer located within the monitor,
(b) a supply of paper located within the apparatus,
(c) whereby the computer program will print a suggested travel plan after receiving inputted data from a user, the suggested travel plan being designed at least in part on the inputted data from a user.

7. An apparatus for providing a travel plan according to claim 6 wherein the travel plan would include written directions as to the proper manner of completing the suggested travel plan, and further wherein the travel plan would include a map detailing the proper manner of completing the suggested travel plan.
